(19) United States
(12) Patent Application Publication
(10) Pub. No.: US 2016/0150355 A1
(43) Pub. Date: May 26, 2016

(54) METHOD OF CONTROLLING OPERATION MODE AND ELECTRONIC DEVICE THEREFOR

(71) Applicant: SAMSUNG ELECTRONICS CO., LTD., Gyeonggi-do (KR)

(72) Inventors: Sung-Sik YOO, Gyeonggi-do (KR); Byung-soo KIM, Gyeonggi-do (KR); Seul-A KIM, Seoul (KR); Chan-Won KIM, Seoul (KR); Seung-Yeon EOM, Seoul (KR); Doo-Man LEE, Seoul (KR); Han-Vit CHUNG, Gyeonggi-do (KR); Seung-Jin CHOI, Seoul (KR)

(21) Appl. No.: 14/899,286

(22) PCT Filed: Jul. 11, 2014
(86) PCT No.: PCT/KR2014/006247

§ 371 Date: Dec. 17, 2015

(30) Foreign Application Priority Data
Jul. 12, 2013 (KR) 10-2013-0082491

(51) Int. Cl. H04W 4/00

(52) U.S. Cl. CPC H04W 4/008

(57) ABSTRACT

A method of controlling an operation mode of an electronic device and the electronic device therefore are provided. The method includes verifying an operation mode of the first electronic device when it is verified that a second electronic device is approached within a predetermined range while transmitting and receiving data with a third electronic device and changing a first mode to a second mode when the first electronic device operates in the first mode.

### TECHNICAL FIELD

The present disclosure relates to a method for controlling an operation mode and an electronic device thereof.

### BACKGROUND ART

As mobile communication technologies have been developed, each of electronic devices can be an essential communication device for people. In addition, electronic devices can provide not only a voice communication function but also various additional functions such as a camera function, a data communication function, a video play function, an audio play function, a messenger function, a scheduling function, and an alarm function. The electronic device can provide various programs which may use the functions. A second electronic device can be a device which is wearable on a body of the user such as his wrist. The second electronic device can interwork with the electronic device. Improve systems and methods can be used.

### DISCLOSURE OF INVENTION

### Solution to Problem

To address the above-discussed deficiencies it is a primary object to provide an apparatus and method for controlling a telephone call mode in an electronic device which interworks with a second electronic device.

In a first example, an apparatus and method are provided for verifying approach of the second electronic device and changing a telephone call mode in an electronic device.

In a second example, an apparatus and method are provided for recognizing conditions information and changing a telephone call mode in an electronic device.

In a third example, a method of a first electronic device is provided. The method includes verifying an operation mode of the first electronic device when it is verified that a second electronic device is approached within a predetermined range while transmitting and receiving data with a third electronic device and changing a first mode to a second mode when the first electronic device operates in the first mode.

In a fourth example, a first electronic device is provided. The first electronic device includes at least one processor and a memory. The at least one processor is configured to output call data received from a third electronic device through a second electronic device. The at least one processor is also configured to transmit call data provided from the second electronic device to the third electronic device. The at least one processor is further configured to change a telephone call mode based on approach of the second electronic device or conditions information of the second electronic device.

In a fifth example, a computer-readable medium is provided. The computer-readable medium is configured to store embodied thereon one or more programs including instructions for allowing a first electronic device to perform the method of verifying an operation mode of the first electronic device when it is verified that a second electronic device is approached within a predetermined range while transmitting and receiving data with a third electronic device and changing a first mode to a second mode when the first electronic device operates in the first mode, when the instructions will be executed by the first electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. lA is an example block diagram illustrating a configuration of an electronic device for controlling a telephone call mode according to this disclosure;

FIG. 1B is an example block diagram illustrating a data processing procedure of a first electronic device and a second electronic device according to this disclosure;

FIG. 1C is an example block diagram illustrating a data processing procedure of a first electronic device and a second electronic device according to this disclosure;

FIG. 2 is an example flowchart illustrating a process of changing an operation mode of a first electronic device according to this disclosure;

FIG. 3 is an example flowchart illustrating a process of changing an operation mode of a second electronic device according to this disclosure;

FIG. 4 is an example flowchart illustrating a process of changing a telephone call mode of a first electronic device according to this disclosure;

FIG. 5 is an example flowchart illustrating a process of changing a telephone call mode of a first electronic device according to this disclosure;

FIGS. 6A to 6C are example diagrams illustrating a process of changing a telephone call module according to this disclosure;

FIGS. 7A and 7B are example diagrams illustrating a process of changing a telephone call module according to this disclosure;

FIGS. 8A and 8B are example diagrams illustrating a process of changing a telephone call module according to this disclosure; and

FIGS. 9A and 9B are example diagrams illustrating a process of changing a telephone call module according to this disclosure.

### BEST MODE FOR CARRYING OUT THE INVENTION

FIGS. lA through 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present disclosure will be described herein below with reference to the accompanying drawings. In the following description, well-known functions or constructions are not described in detail since they would obscure the disclosure in unnecessary detail.

As mobile communication technologies have been developed, each of electronic devices can be an essential communication device for people. In addition, electronic devices can provide not only a voice communication function but also various additional functions such as a camera function, a data communication function, a video play function, an audio play function, a messenger function, a scheduling function, and an alarm function. The electronic device can provide various programs which may use the functions.

In general, a user of the electronic device can control the electronic device which is in a hand-held state. For example, the user can locate the electronic device held by him or her between his or her ear and mouth to use a communication function of the electronic device.

A second electronic device can be a device which is wearable on a body of the user such as his wrist. Because the second electronic device can interwork with the electronic device, a problem that the electronic device must be held by the user can be solved. For example, the user can establish a call connection with a counterpart using the second electronic device in a state where he or she keeps the electronic device in his or her pocket or bag, and the like.

Therefore, the electronic device which interworks with the second electronic device can operate in a mode for establishing a call connection using its speaker and microphone or using a speaker and microphone of the second electronic device.

A touch screen which is recently used by various methods can be an input or display device which inputs or displays information on one screen. Accordingly, when the touch screen is installed in the electronic device, a separate input device such as a keypad can be removed from the electronic device and a display size of the electronic device can be increased. For example, when a full touch screen using the entire screen is installed in the electronic device, a screen size can be enlarged by using a full surface of the electronic device as its screen.

The electronic device can connect to a second electronic device and be under control of the second electronic device.

For example, the electronic device can connect with the second electronic device which is wearable on a body of its user such as his or her wrist and establish a call connection with a counterpart which is being connected therewith using a speaker and microphone of the second electronic device.

The electronic device can sense input of an input means such as a stylus pen, an electronic pen, and the like, input of fingers of its user, a voice command, hardware-like button input, or specific input received through other sensors, and the like and operate in a mode (such as a first telephone call mode) for establishing a call connection with a counterpart using its speaker and microphone and in a mode (such as a second telephone call mode) for establishing a call connection with the counterpart using a speaker and microphone of the second electronic device.

There can be conditions in which the electronic device must change a telephone call mode. For one example, when the remaining capacity of a battery of the second electronic device is insufficient while the second telephone mode is performed, there can be conditions in which the electronic device changes the second telephone call mode to the first telephone call mode.

For another example, when there are peripheral noises in which it is impossible for the user to establish a call connection with a counterpart while the second telephone call mode is performed, there can be conditions in which the electronic device changes the second telephone call mode to the first telephone call mode.

For another example, when there are conditions in which the second electronic device is controlled while the second telephone call mode is performed, there can be conditions in which the electronic device changes the second telephone call mode the first telephone call mode. On the other hand, when there are conditions in which the first electronic device is controlled while the first telephone call mode is performed, there can be conditions in which the electronic device changes the first telephone call mode to the second telephone call mode.

Hereinafter, the electronic device according to this disclosure can recognize approach of the second electronic device and change a telephone call mode. For example, the electronic device can verify approach of the second electronic device using a local-area communication module such as a Near Field Communication (NFC) module and a Bluetooth module or a sensor which can sense proximity.

The electronic device can recognize conditions information and change its telephone call mode. For example, the electronic device can sense the remaining capacity of a battery of the second electronic device, noises around the second electronic device, and a current position of the second electronic device, its motion, and the like and change a telephone call mode.

The electronic device can support its communication function. In an embodiment, the electronic device can support only one of transmission and reception functions. For example, the electronic device can be a receive-only device which does not support the transmission function.

That is, the electronic device can be a portable electronic device. Also, the electronic device can be one or combination of one or more of various devices which include a portable terminal, a mobile phone, a media player, a tablet computer, a handheld computer, a Personal Digital Assistant (PDA), a desktop computer, a refrigerator, a multi-function peripheral, a video game console, a digital camera, a Mobile Internet Device (MID), a Ultra Mobile Personal Computer (UMPC), a navigation device, a smart TV, a digital watch, a Moving Picture Experts Group (MPEG) layer 3 (MP3) player, an electronic album, a part of furniture or a building/structure including an electronic device, an electronic board, an electronic signature receiving device, or a projector. It is obvious to a person skilled in the art that the electronic device according to various embodiments of the present disclosure is not limited to the above-described devices.

Also, a description will be given for an electronic device including its touch screen. Although the electronic device does not include the touch screen, it is easily understood by those skilled in the art that embodiments described in the present application can be suitably applied to an electronic device or computing device having an input means which differs from a display.

In addition, the second electronic device can be one of various devices which can interwork with the electronic device. For example, the second electronic device can be a device which is wearable on a body of the user. Herein, to be wearable on the body of the user can include to fix the second electronic device to the body by a band type and to hang the second electronic device up on the body using a wire. In addition, to fix the second electronic device to the body using a supporter can be included.

FIG. lA is an example block diagram illustrating a configuration of an electronic device according to this disclosure.

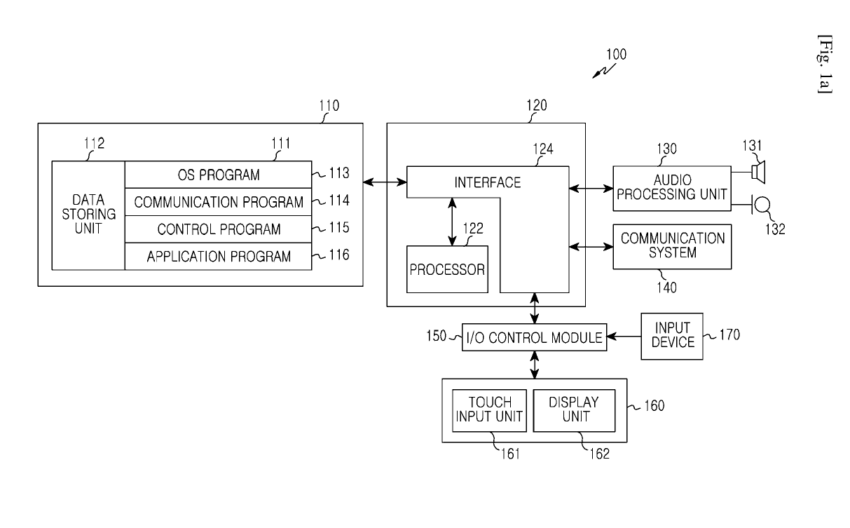

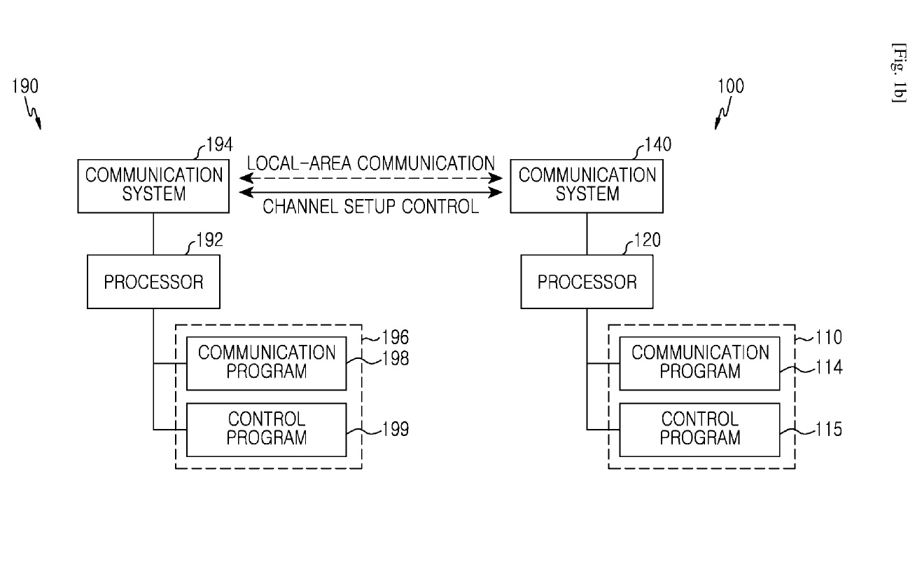

Referring to FIG. 1A, the electronic device denoted by 100 can include a memory 110, a processor unit 120, an audio processing unit 130, a communication system 140, an Input/Output (I/O) control module 150, a touch screen 160, or an input device 170. At least one of these constitutions can be a plurality of constitutions.

A description will be given for respective components as follows.

The memory 110 can include a program storing unit 111 for storing programs for controlling operations of the electronic device 100 and a data storing unit 112 for storing data generated while the programs are executed. For example, the data storing unit 112 can store various updatable data such as a telephone directory, an originating message, or a terminating message, and store information about a second electronic device which can interwork therewith. When the electronic device 100 interworks with the second electronic device using Bluetooth communication, the data storing unit 112 can store a Bluetooth ID, pairing information, etc. for the second electronic device.

In addition, the data storing unit 112 can store a reference value for determining a time point of changing a telephone call mode.

In an embodiment, the electronic device can change a telephone call mode using information indicating whether the second electronic device is approached thereto, conditions information, and the like.

In an embodiment, the data storing unit 112 can store reference data for determining approach of the second electronic device and reference data for recognizing conditions.

The program storing unit 111 can include an OS program 113, a communication program 114, a control program 115, or at least one application program 116. Herein, the programs included in the program storing unit 111 can be expressed in an instruction set as a set of instructions. In addition, the programs included in the program storing unit 111 can be expressed as hardware-like configuration. For example, the electronic device 100 can include an OS module, a communication module, a control module, and the like.

The OS program 113 can include several software components for controlling a general system operation. The control of this general system operation means, for example, memory management or control, storage hardware (device) control or management, power control or management, and the like. This OS program 113 can perform a function for smoothly performing communication between several hardware (devices) and program components (modules).

The communication program 114 can include at least one software component for controlling communication with at least one counterpart electronic device using the communication system 140.

For example, the communication program 114 can search a counterpart electronic device for performing communication, set a channel for the communication with the counterpart electronic device, and transmit and receive data. For example, the communication program 114 can establish a call connection with a third party in a state where the electronic device connects with the second electronic device, transmit voice data received from the third party to the second electronic device, and transmit voice data received from the second electronic device to the third party.

The control program 115 can include at least one software component for determining a condition for selecting a mode for establishing a call connection with a counterpart using the speaker 131 and the microphone 132 of the electronic device 100 and a mode for establishing a call connection with the counterpart using a speaker and a microphone of the second electronic device based on approach of the second electronic device, conditions information of the electronic device, and the like and performing a control operation to operate in the mode corresponding to the determined result.

The control program 115 can verify a telephone call mode which operates using local-area communication such as NFC and Bluetooth communication.

In addition, the control program 115 can verify a telephone call mode which operates using motion information, position information, the remaining capacity of a battery of the electronic device 100, and the like.

The application program 116 can include a software component for at least one application program installed in the electronic device 100. The application program 116 can include a program for changing a telephone call mode according to recognition of conditions information of the electronic device 100 and approach of the second electronic device. As described above, a function for changing the telephone call mode according to the conditions information or the approach of the second electronic device can be provided as one application.

In addition, the program storing unit 111 can include a display program for providing and displaying graphics on the touch screen 160.

The term “graphics” can mean that texts, webpages, icons, digital images, videos, animations, and the like are included.

In addition, the display program can include several software components related to a user interface.

The display program can display a telephone call mode change operation, an operation for setting a telephone call mode change condition, and the like.

The processor unit 120 can include at least one processor 122 or an interface 124. Herein, at least the one processor 122 or the interface 124 can be integrated in at least one Integrated Circuit (IC) or be separately implemented.

The interface 124 can play a role as a memory interface for controlling that the processor 122 accesses the memory 110.

In addition, the interface 124 can play a role as a peripheral interface for controlling connection between an I/O peripheral of the electronic device 100 and the processor 122.

The processor 122 can perform a control operation to change a telephone call mode according to a predetermined condition using at least one software program.

Herein, the processor 122 can include a processor for performing a control operation to execute at least one program stored in the memory 110 and perform a function corresponding to the corresponding program.

That is, a telephone call mode change function of the electronic device 100 can be performed using software such as the program stored in the memory 110 or hardware such as the processor 122.

The audio processing unit 130 can provide an audio interface between a user and the electronic device 100 through a speaker 141 and a microphone 142.

The communication system 140 can perform a communication function for voice or data communication of the electronic device 100. Herein, the communication system 140 can be classified into a plurality of communication sub-modules for supporting different communication networks. For example, the communication network can include, but is not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, or an NFC network, and the like.

The I/O control module 150 can provide an interface between an I/O device such as the touch screen 160 or the input device 170 and the processor unit 120.

The touch screen 160 is an I/O device for displaying or inputting information, and can include a touch input unit 161 and a display unit 162.

The touch input unit 161 can provide touch information sensed through a touch panel to the processor unit 120 through the I/O control module 150. Herein, the touch input unit 161 can change the touch information to a command structure such as touch_down, touch_move, or touch_up and provide the changed touch information to the processor unit 120. The touch input unit 161 can sense input for changing a telephone call mode, input for setting a telephone call mode change condition, and the like and provide the sensed input to the processor unit 120.

The display unit 162 can display state information of the electronic device 100, characters input by the user, moving pictures, or still pictures, and the like. For example, the display unit 162 can display a screen for setting a telephone call mode change operation, a telephone call mode change condition, and the like.

The input device 170 can provide input data generated by selection of the user to the processor unit 120 through the I/O control module 150. For example, the input device 170 can include only a control button for controlling the electronic device 100. The input device 170 can sense input for changing a telephone call mode, input for setting a telephone call mode change condition, and the like and provide the sensed input to the processor unit 120.

Although it is not shown in FIG. 1A, the electronic device 100 can further include components for providing additional functions, such as a broadcasting receiving module for receiving broadcasting, a digital sound source play module such as an MP3 module, a local-area wireless communication module for performing local-area wireless communication, an image sensor module for acquiring image data, or a proximity sensor module for performing proximity sensing and software for operations of these components.

FIG. 1B is an example block diagram illustrating a data processing procedure of a first electronic device and a second electronic device according to this disclosure.

Referring to FIGS. lA and 1B, the first electronic device denoted by 100 can connect with the second electronic device denoted by 190 using local-area communication and receive a call from a third electronic device. For example, the first electronic device 100 and the third electronic device can be a mobile communication device, respectively. The second electronic device 190 can be an accessory device which can connect with the first electronic device 100 by Bluetooth communication. The first electronic device 100 can provide the call received from the third electronic device to the second electronic device 190 connected by Bluetooth communication.

The processor 122 of the first electronic device 100 can perform a control operation to connect with the second electronic device 190 through at least one communication network including the communication system 140 through the communication program 114 stored in the memory 110. For one example, the processor 122 can perform a control operation to connect with the second electronic device 190 using Bluetooth communication, a wireless LAN, NFC, and the like. For example, the processor 122 can perform a control operation to connect with the third electronic device through one of communication networks such as a CDMA network, a W-CDMA network, a GSM network, a Voice over Internet Protocol (VoIP) network, and the like.

The processor 122 of the first electronic device 100 can perform a first telephone call mode for decoding a call voice received from the third electronic device through the communication program 114 and outputting the decoded call voice through the speaker 131. The processor 122 of the first electronic device 100 can perform the first telephone call mode for encoding voice data of the user input through the microphone 132 and transmit the encoded voice data to the third electronic device.

The processor 122 of the first electronic device 100 can perform a second telephone call mode for encoding a call voice received from the third electronic device through the communication program 114 and transmit the encoded call voice to the second electronic device 190. The processor 120 of the first electronic device 100 can perform the second telephone call mode for encoding a call voice received from the second electronic device 190 and transmit the encoded call voice to the third electronic device. For example, the processor 122 of the first electronic device 100 can establish a call connection with the third electronic device through one of communication networks such as the CDMA network, the W-CDMA network, the GSM network, the VoIP network, etc. through the communication program 114. The processor 120 of the first electronic device 100 can perform a processing operation to output a call voice received from the third electronic device through the second electronic device 190.

The processor 122 of the first electronic device 100 can perform a control operation to determine a time point of changing a telephone call mode through the control program 115 stored in the memory 110. The processor 122 can ascertain approach of the second electronic device 190 through the control program 115 and change a telephone call mode based on the ascertained result. For example, the processor 100 can determine a time point of when signal strength of the second electronic device 190 connected by local-area communication, such as NFC and Bluetooth communication, through the control program 115 is greater than or equal to a threshold value as a time point of changing a telephone call mode.

A processor 192 of the second electronic device 190 can perform a control operation to connect with the first electronic device 100 through at least one communication network including a communication system 194 through a communication program 198 stored in a memory 196.

The processor 192 of the second electronic device 190 can perform a control operation to decode a call voice received from the first electronic device 100 through the communication program 198 and output the decoded call voice through a speaker of the second electronic device 190. The processor 192 of the second electronic device 190 can perform a processing operation to encode voice data of a user of the second electronic device 190, which is input through a microphone of the second electronic device 190, and transmit the encoded voice data to the first electronic device 100.

For example, the processor 192 of the second electronic device 190 can a processing operation to connect with the first electronic device 100 through a communication network, such as a Bluetooth network, an Infrared Data Association (IrDA) network, and a wireless LAN, through the communication program 198. The processor 192 of the second electronic device 190 can be a processing operation to output a call voice received from the first electronic device 100 through the speaker and transmit a call voice input through the microphone to the first electronic device 100.

The processor 192 of the second electronic device 190 can perform a control operation to determine a time point of changing a telephone call mode through the control program 199. The processor 192 can ascertain approach of the first electronic device 100 through the control program 199 and change a telephone call mode based on the ascertained result. For example, the processor 192 can determine a time point of when signal strength of the first electronic device 100 connected through local-area communication, such as NFC and Bluetooth communication, through the control program 199 is greater than or equal to a threshold value as a time point of changing a telephone call mode.

When a request for instructing a change in a telephone call mode is received from the first electronic device 100 through the control program 199, the processor 192 can determine a time point of receiving the request as a time point of changing a telephone call mode.

As described herein, although the first electronic device 100 and the second electronic device 190 are classified and described, the first electronic device 100 can perform an operation of the second electronic device 190. Also, the second electronic device 190 can perform an operation of the first electronic device 100.

In an embodiment, the user can wear the second electronic device on his or her wrist of one hand and establish a call connection with a user of the third electronic device using the first electronic device 100 which is held by the other hand. In an embodiment, each of the first and second electronic devices 100 and 190 can include an NFC module and sense approach of a counterpart electronic device using the NFC mode.

FIG. 1C is an example block diagram illustrating a data processing procedure of a first electronic device and a second electronic device according to this disclosure.

Referring to FIGS. lA to 1C, the first electronic device 100 can connect with the second electronic device 190 using local-area communication and receive a call from a third electronic device. For example, the first electronic device 100 can provide the call received from the third electronic device to the second electronic device 190 connected by Bluetooth communication.

The processor 122 of the first electronic device 100 can perform a control operation to connect with the second electronic device 190 through at least one communication network including the communication system 140 through the communication program 114 stored in the memory 110. For example, the processor 122 can perform a control operation to connect with the second electronic device 190 using Bluetooth communication, a wireless LAN, NFC, and the like. For example, the processor 122 can perform a control operation to connect with the third electronic device through one of communication networks such as a CDMA network, a W-CDMA network, a GSM network, a VoIP network, and the like.

The processor 122 of the first electronic device 100 can perform a first telephone call mode for decoding a call voice received from the third electronic device through the communication program 114 and output the decoded call voice through the speaker 131. The processor 122 of the first electronic device 100 can perform the first telephone call mode for encoding voice data of the user input through the microphone 132 and transmit the encoded voice data to the third electronic device.

The processor 122 of the first electronic device 100 can perform a second telephone call mode for encoding a call voice received from the third electronic device through the communication program 114 and transmit the encoded call voice to the second electronic device 190. The processor 122 of the first electronic device 100 can perform the second telephone call mode for encoding a call voice received from the second electronic device 190 and transmit the encoded call voice to the third electronic device.

For example, the processor 122 of the first electronic device 100 can establish a call connection with the third electronic device through one of communication networks such as the CDMA network, the W-CDMA network, the GSM network, the VoIP network, and the like through the communication program 140. The processor 122 of the first electronic device 100 can perform a processing operation to output a call voice received from the third electronic device through the second electronic device 190.

The processor 122 of the first electronic device 100 can perform a control operation to determine a time point of changing a telephone call mode through the control program 115. The processor 122 can ascertain conditions information of the first electronic device 100 and change a telephone call mode based on the ascertained result. For example, when motion information, the remaining capacity of a battery, peripheral noises, position information, and the like of the first electronic device 100 and/or the second electronic device 190, which are collected through sensor module 180 through the control program 115, satisfy predetermined conditions, the processor 122 can determine a time point of satisfying the predetermined conditions as a time point of changing a telephone call mode.

The processor 192 of the second electronic device 190 can perform a control operation to connect with the first electronic device 100 through at least one communication network including the communication system 194 through the communication program 198 stored in the memory 196.

The processor 192 of the second electronic device 190 can perform a control operation to decode a call voice received from the first electronic device 100 through the communication program 198 and output the decoded call voice through the speaker of the second electronic device 190. The processor 192 of the second electronic device 190 can perform a processing operation to encode voice data of the user of the second electronic device 190, which is input through the microphone of the second electronic device 190, and transmit the encoded voice data to the first electronic device 100.

For example, the processor 192 of the second electronic device 190 can be a processing operation to connect with the first electronic device 100 through a communication network, such as a Bluetooth network, an IrDA network, and a wireless LAN, through the communication program 198. The processor 192 of the second electronic device 190 can be a processing operation to output a call voice received through the first electronic device 100 through the speaker and transmit a call voice input through the microphone to the first electronic device 100.

The processor 192 of the second electronic device 190 can perform a control operation to determine a time point of changing a telephone call mode through the control program 199. The processor 192 can ascertain conditions information of the first electronic device 100 through the control program 199 and change a telephone call mode based on the ascertained result. For example, when motion information, the remaining capacity of a battery, peripheral noises, position information, and the like of the first electronic device 100 and/or the second electronic device 190, which are collected through sensors through the control program 115, satisfy predetermined conditions, the processor 122 can determine a time point of satisfying the predetermined conditions as a time point of changing a telephone call mode.

For example, when a request for instructing a change in a telephone call mode is received from the first electronic device 100 through the control program 199, the processor 192 can determine a time point of receiving the request as a time point of changing a telephone call mode.

As described herein, although the first electronic device 100 and the second electronic device 190 can be classified and described, the first electronic device 100 can perform an operation of the second electronic device 190. Also, the second electronic device 190 can perform an operation of the first electronic device 100.

An electronic device can include at least one processor, and a memory, wherein at least the one processor is configured to output call data received from a third electronic device through a second electronic device, transmit call data provided from the second electronic device to the third electronic device, and change a telephone call mode based on approach of the second electronic device or conditions information of the second electronic device.

In an embodiment, at least the one processor can be configured to change a telephone call mode to output call data received from the third electronic device through a speaker of the first electronic device and transmit call data input from a microphone of the first electronic device to the third electronic device.

In an embodiment, at least the one processor can be configured to verify approach of the second electronic device through non-contact communication.

In an embodiment, at least the one processor can be configured to recognize conditions information based on any one of motion information, position information, remaining capacity information of a battery, time information, and peripheral noise information.

In an embodiment, at least the one processor can be configured to verify approach of the second electronic device in a state where the first electronic device connects with the second electronic device using local-area communication.

In an embodiment, at least the one processor can be configured to sense a tagging operation with the second electronic device and verify approach of the second electronic device.

In an embodiment, at least the one processor can be configured to determine that the first electronic device is tagged with the second electronic device when the first electronic device comes in contact with the second electronic device physically or is adjacent to the second electronic device.

The second electronic device can be configured to include at least any one of an extendable speaker and an electronic watch.

At least the one processor can be configured to output call data received from the third electronic device through the second electronic device through at least any one of a CDMA network, a W-CDMA network, a GSM network, and a VoIP network.

An electronic device can include a first communication unit for establishing a connection with the second electronic device. The electronic device can also include a second communication unit for establishing a connection with the third electronic device. The electronic device can further include a processor for, if the second electronic device is approached within a predetermined range while connection with the third electronic device, verifying an operation mode of the electronic device, if the electronic device operates in the first operation mode, changing the first operation mode to a second operation mode, and if the electronic device operates in the second operation mode, changing the second operation mode to the first operation mode.

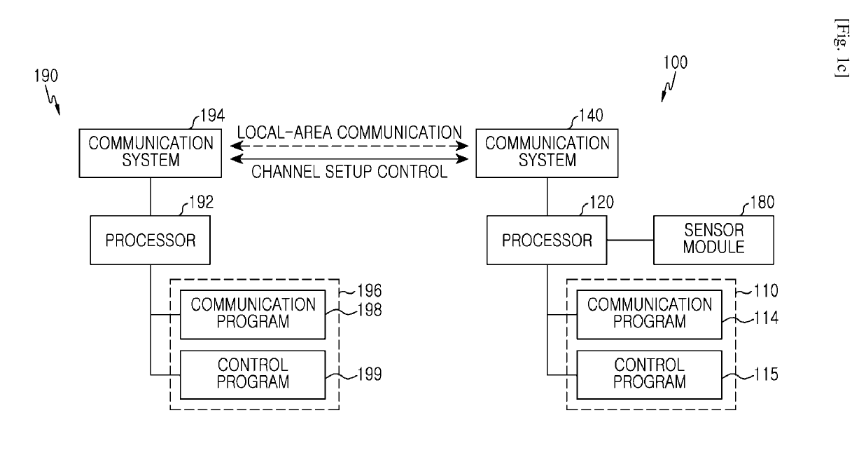

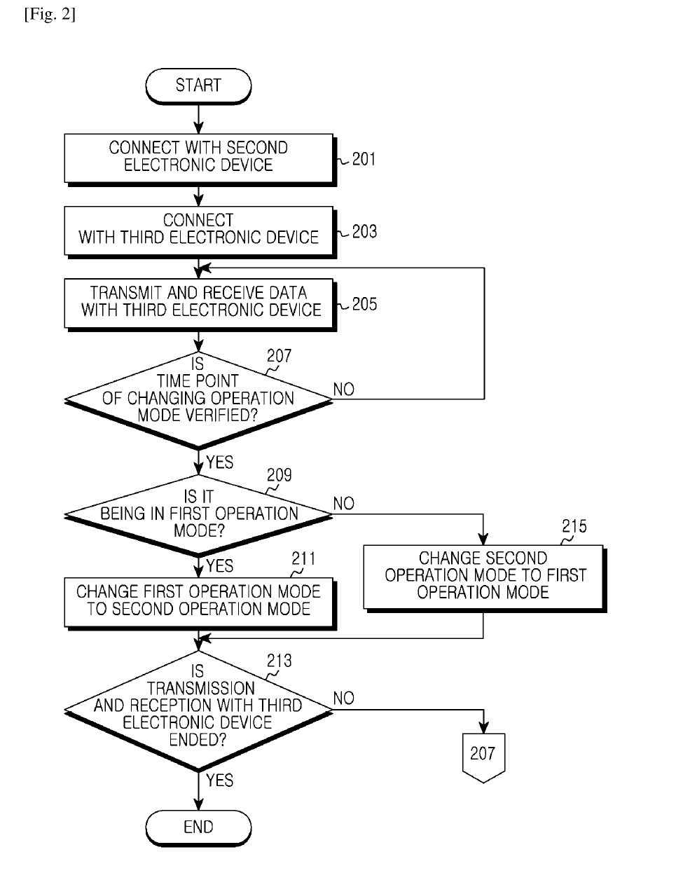

FIG. 2 is an example flowchart illustrating a process of changing an operation mode of a first electronic device according to this disclosure.

Referring to FIG. 2, the first electronic device can be a device which can perform first communication with the second electronic device. Also, the first electronic device can be a device which can perform second communication with a third electronic device. For example, the first electronic device can perform the first communication using a Bluetooth function, a wireless LAN function, an NFC function, an IrDA function, etc. The first electronic device can perform the second communication using a voice call function, a video call function, a Wi-Fi direct function, etc.

The first electronic device can connect with the second electronic device through the first communication in step 201. Herein, the second electronic device can be a device which can interwork with the first electronic device. The second electronic device can be a device which is wearable on a body of a user, such as a smart watch, smart glasses, and a Bluetooth headset.

The first electronic device can connect with the third electronic device through the second communication in step 203. For example, the first electronic device can connect with the third electronic device using communication such as CDMA communication, W-CDMA communication, GSM communication, and VoIP communication.

The first electronic device can transmit and receive data with the third electronic device in step 205. For example, performing voice communication with the third electronic device, the first electronic device can transmit and receive voice data with the third electronic device. For example, performing video communication with the third electronic device, the first electronic device can transmit and receive video data and voice data with the third electronic device. For example, performing a Wi-Fi direct function with the third electronic device, the first electronic device can receive audio data and/or video data from the third electronic device.

The first electronic device can verify a time point of changing an operation mode in step 207. Herein, the operation mode can be a first operation mode for operating a speaker and microphone of the first electronic device and a second operation mode for operating a speaker and microphone of the second electronic device. The first electronic device can verify a time point of changing an operation mode based on whether the second electronic device is approached thereto or conditions information. For example, the first electronic device can determine the approach of the second electronic device or sense a device for supporting non-contact communication such as NFC using strength of local-area communication signals, and determine the approach of the second electronic device. For example, the first electronic device can acquire conditions information such as the remaining capacity of a battery, peripheral noises, position information, and motion information and verify whether the acquired conditions information satisfies a predetermined operation mode change condition.

The first electronic device can verify whether a mode for transmitting and receiving data with the third electronic device is the first operation mode in step 209.

Verifying a time point of changing an operation mode while the mode is the first operation mode, the first electronic device can change the first operation mode to the second operation mode in step 211.

Verifying a time point of changing an operation mode while the mode is the second operation mode, the first electronic device can change the second operation mode to the first operation mode in step 215.

The first electronic device can determine whether it is ended transmit and receive data with the third electronic device in step 213. The first electronic device can change the operation mode until the data transmission is ended.

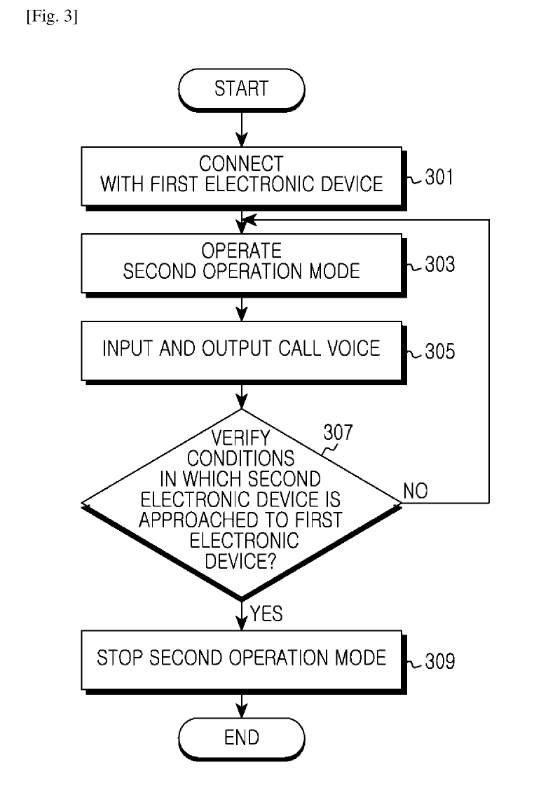

FIG. 3 is an example flowchart illustrating a process of changing an operation mode of a second electronic device according to this disclosure.

Referring to FIG. 3, the second electronic device can be a device which can interwork with an electronic device (such as a first electronic device) and be wearable on a body of its user. For example, the second electronic device can include a smart watch, smart glasses, a Bluetooth headset, and the like.

The second electronic device can connect with the first electronic device in step 301. For example, the second electronic device can connect with the first electronic device using one of local-area networks such as a Bluetooth network, a wireless LAN, and an IrDA network.

The second electronic device can operate a second operation mode in step 303. Herein, the second operation mode can mean a mode in which the second electronic device receives voice data from the first electronic device and outputs the received voice data to its speaker and a mode in which the second electronic device transmits voices input through its microphone to the first electronic device.

The second electronic device can input and output a call voice using the second operation mode in step 305.

The second electronic device can verify conditions in which it is approached to the first electronic device in which in step 307. The second electronic device can verify conditions in which it is approached to the first electronic device based on signal strength of local-area communication or by sensing an electronic device which supports non-contact communication. The second electronic device can verify conditions in which it is approached to the first electronic device directly or receive information indicating conditions in which it is approached to the first electronic device.

The second electronic device can stop the second operation mode in the conditions in which it is approached to the first electronic device in step 309. That is, if the first electronic device is approached to the second electronic device in the conditions in which the speaker and microphone of the second electronic device is used, the second electronic device can use a speaker and microphone of the first electronic device.

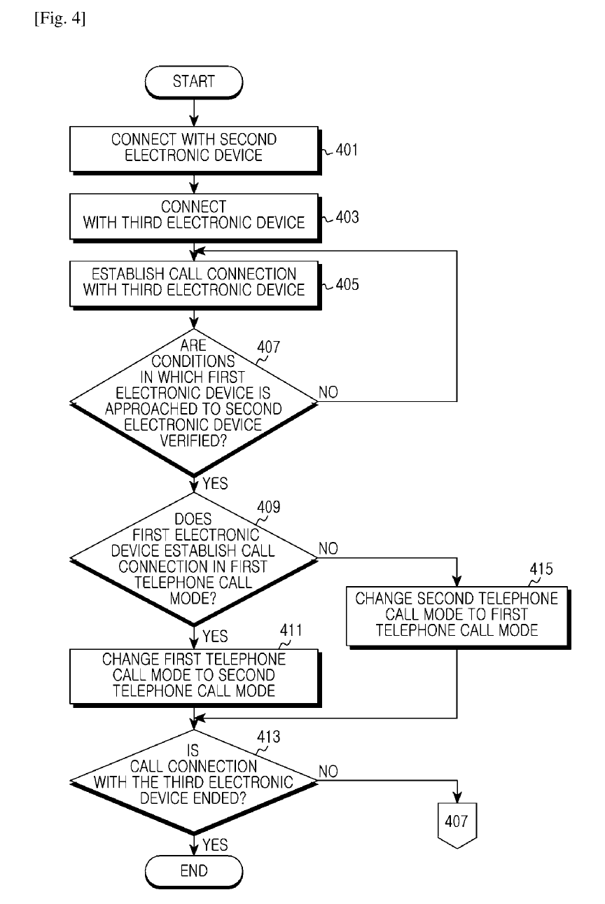

FIG. 4 is an example flowchart illustrating a process of changing a telephone call mode of a first electronic device according to this disclosure.

Referring to FIG. 4, the first electronic device can be a device which can perform first communication with the second electronic device. Also, the first electronic device can be a device which can perform second communication with a third electronic device. For example, the first electronic device can perform the first communication using a Bluetooth function, a wireless LAN function, an NFC function, an IrDA function, and the like. The first electronic device can perform the second communication using a voice call function, a video call function, a Wi-Fi direct function, and the like.

The first electronic device can connect with the second electronic device through the first communication in step 401. Herein, the second electronic device can be a device which can interwork with the first electronic device. The second electronic device can be a device which is wearable on a body of its user, such as a smart watch, smart glasses, and a Bluetooth headset.

The first electronic device can connect with the third electronic device through the second communication in step 403. For example, the first electronic device can connect with the third electronic device using communication such as CDMA communication, W-CDMA communication, GSM communication, and VoIP communication.

The first electronic device can establish a call connection with a third electronic device in step 405.

The first electronic device can verify whether it is approached to the second electronic device during the call connection in step 407. The first electronic device can determine whether there are conditions in which it comes in contact with the second electronic device physically or conditions in which it is adjacent enough to determine that it comes in contact with the second electronic device physically.

For one example, the first electronic device can connect with the second electronic device using local-area communication such as Bluetooth communication, IrDA communication, wireless LAN communication, and Zigbee communication. Therefore, the first electronic device can sense signal strength of a threshold value or more and determine that it is approached to the second electronic device.

For example, the first electronic device can verify whether being approached to the second electronic device using non-contact communication such as NFC, FeliCa communication, and Radio Frequency IDentification (RFID) communication.

Verifying that the first electronic device is not approached to the second electronic device during the call connection, the first electronic device can maintain the call connection with the third electronic device.

Verifying that the first electronic device is approached to the second electronic device during the call connection, the first electronic device can verify whether to establish the call connection in a first telephone call mode in step 409. Herein, the first telephone call mode can be a mode in which the first electronic device establishes the call connection with the third electronic device using its speaker and microphone.

Verifying that the first electronic device is approached to the second electronic device while establishing the call connection in the first telephone call mode, the first electronic device can change the first telephone call mode to a second telephone call mode in step 411. Herein, the second telephone call mode can be a mode in which the first electronic device establishes a call connection with the third electronic device using a speaker and microphone of the second electronic device. When the first electronic device operates in the second telephone call mode, the second electronic device can provide a call voice received from the third electronic device to the first electronic device using a protocol for the first electronic device and provide a call voice received from the first electronic device to the third electronic device using a protocol for the third electronic device.

Verifying that the first electronic device is approached to the second electronic device while establishing the call connection in the second telephone call mode, the first electronic device can change the second telephone call mode to the first telephone call mode in step 415. For example, the first electronic device can release only a channel with the second electronic device temporarily while maintaining the connection with the second electronic device. The first electronic device can release the channel with second electronic device by releasing the connection with the second electronic device.

The first electronic device can determine whether it is ended call connection with the third electronic device in step 413. The first electronic device can determine whether it is approached to the second electronic device until the call connection with the third electronic device is ended and change its telephone call mode.

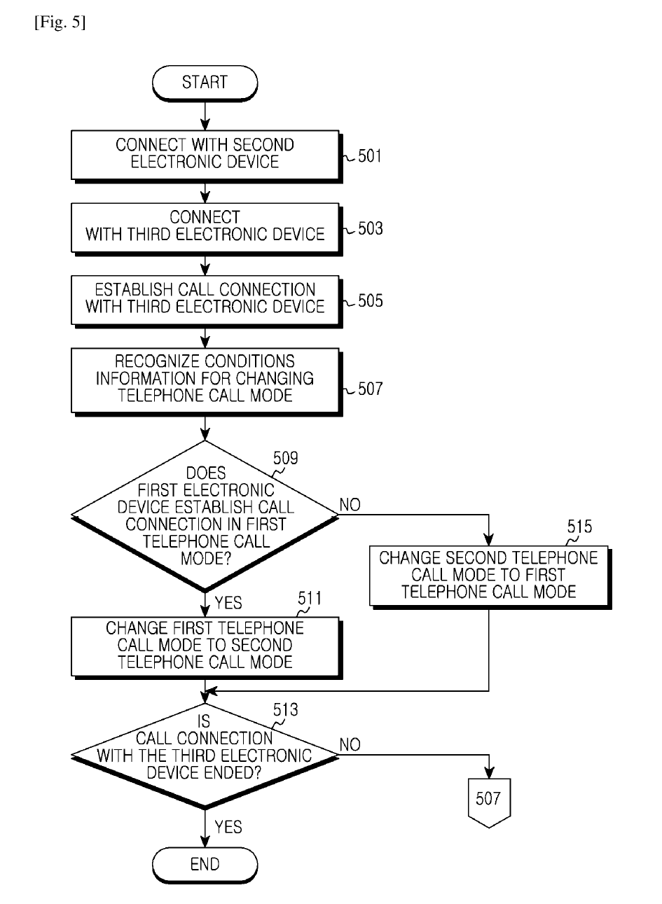

FIG. 5 is an example flowchart illustrating a process of changing a telephone call mode of a first electronic device according to this disclosure.

Referring to FIG. 5, the first electronic device can be a device which can perform first communication with the second electronic device. Also, the first electronic device can be a device which can perform second communication with a third electronic device. For example, the first electronic device can perform the first communication using a Bluetooth function, a wireless LAN function, an NFC function, an IrDA function, and the like. The first electronic device can perform the second communication using a voice call function, a video call function, a Wi-Fi direct function, and the like.

The first electronic device can connect with the second electronic device through the first communication in step 501. Herein, the second electronic device can be a device which can interwork with the first electronic device. In an embodiment, the second electronic device can be a device which is wearable on a body of its user, such as a smart watch, smart glasses, and a Bluetooth headset.

The first electronic device can connect with the third electronic device through the second communication in step 503. For example, the first electronic device can connect with the third electronic device using communication such as CDMA communication, W-CDMA communication, GSM communication, and VoIP communication.

The first electronic device can establish a call connection with the third electronic device in step 505.

The first electronic device can recognize conditions information for changing a telephone call mode in step 507. For example, the first electronic device can sense the remaining capacity of a battery of the second electronic device, noises around the second electronic device, a current position of the second electronic device, its motion, and the like of the second electronic device and change a current telephone call mode.

Recognizing the conditions information for changing the current telephone call mode, that is, recognizing conditions information which satisfies a predetermined condition, the first electronic device can verify whether to establish the call connection in a first telephone call mode in step 509. Herein, the first telephone call mode can be a mode in which the first electronic device establishes the call connection with the third electronic device using its speaker and microphone.

Recognizing the conditions information for changing the telephone call mode while establishing the call connection in the first telephone call mode, the first electronic device can change the first telephone call mode to a second telephone call mode in step 511. Herein, the second telephone call mode can be a mode in which the first electronic device establishes a call connection with the third electronic device using a speaker and microphone of the second electronic device. When the first electronic device operates in the second telephone call mode, the second electronic device can provide a call voice received from the third electronic device to the first electronic device using a protocol for the first electronic device and provide a call voice received from the first electronic device to the third electronic device using a protocol for the third electronic device.

Recognizing the conditions information for changing the telephone call mode while establishing the call connection in the second telephone call mode, the first electronic device can change the second telephone call mode to the first telephone call mode in step 515.

The first electronic device can determine whether it is ended call connection with the third electronic device in step 513. The first electronic device can determine whether it is approached to the second electronic device until the call connection with the third electronic device is ended and change its telephone call mode.

The first electronic device can recognize the conditions information until the call connection with the third electronic device is ended and change its telephone call mode.

FIGS. 6A to 6C illustrate an example process of changing a telephone call module according to this disclosure.

Referring to FIGS. 6A to 6C, a user can establish a call connection with a counterpart using a first electronic device and a second electronic device.

For example, the first electronic device can support a first telephone call mode for outputting a call voice received from the counterpart through its speaker and provide a call voice input through its microphone to the counterpart.

For example, the first electronic device can support a second telephone call mode for outputting a call voice received from the counterpart through a speaker of the second electronic device and provide a call voice of the user received from the second electronic device to the counterpart.

In FIGS. 6A to 6C, a device 601 (such as a smart device) worn on the left wrist of the user can be the second electronic device. A device 603 (such as a smart phone) held by the right band of the user can be the first electronic device.

Each of the first electronic device 603 and the second electronic device 601 can support non-contact communication such as NFC, FeliCa communication, and RFID communication.

The first electronic device 603 can determine that the second electronic device 601 is approached thereto using this communication and determine a time point of changing a telephone call mode based on the determined result.

For example, verifying the approach of the second electronic device 601 while establishing a call connection with the counterpart using the first telephone call mode, the first electronic device 603 can change the first telephone call mode to the second telephone call mode.

For example, verifying the approach of the second electronic device 601 while establishing a call connection with the counterpart using the second telephone call mode, the first electronic device 603 can change the second telephone call mode to the first telephone call mode.

FIGS. 6A to 6C illustrate conditions in which the user approaches the first electronic device 603 to the second electronic device 601 while establishing a call connection with a counterpart “jeremy” using the second electronic device 601, changes a telephone call mode (such as reference number 605), and maintains the call connection using the first electronic device 603 (such as reference number 607).

The conditions to which an embodiment is applied can be assumed as follows.

There can be conditions in which the first electronic device 603 is controlled while the user performs the first telephone call mode. For example, there can be conditions in which the user inquires records such as images and telephone numbers stored in the first electronic device 603 while the first electronic device 603 operates in a telephone call mode. The user can maintain a call connection by tagging the second electronic device 601 to the first electronic device 603 and move the second electronic device 601 to his or her ear and control the first electronic device 603 simultaneously. The first electronic device 603 can change a telephone call mode in a time point of being tagged with the second electronic device 602 and maintain a call connection using the second electronic device 601.

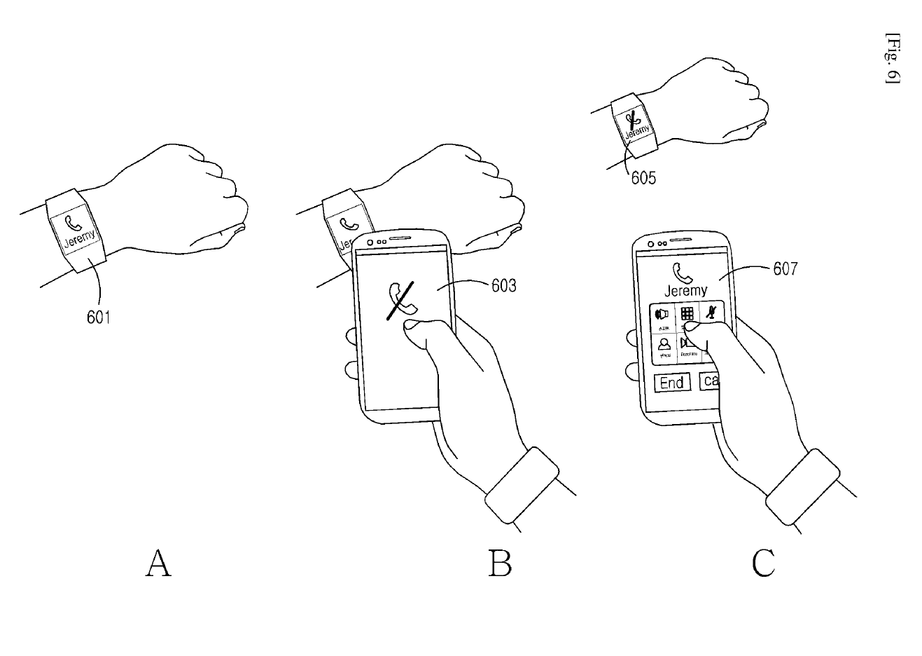

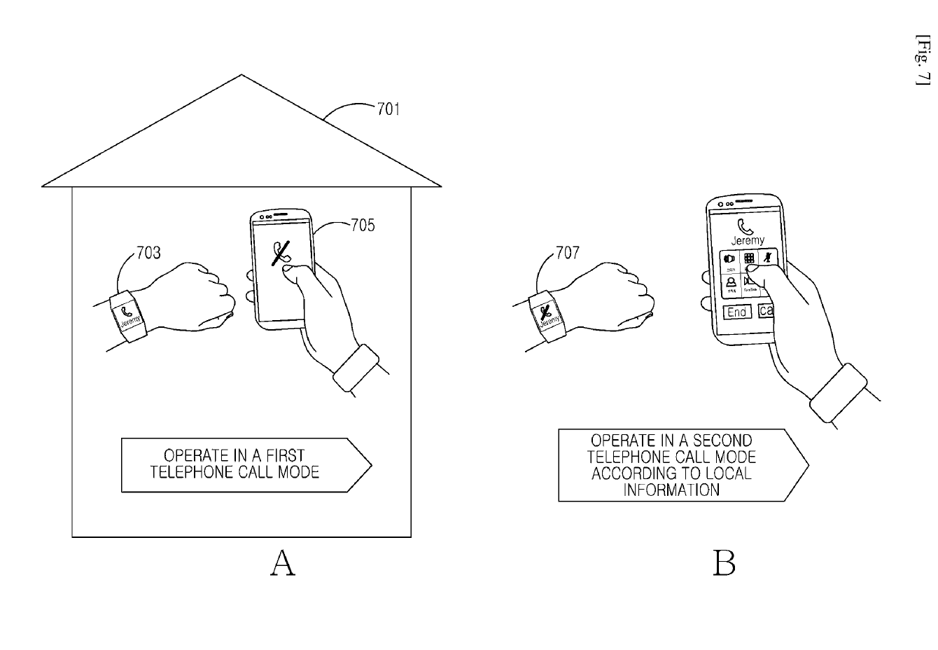

FIGS. 7A and 7B illustrate an example process of changing a telephone call module according to this disclosure.

Referring to FIGS. 7A and 7B, a user can establish a call connection with a counterpart using a first electronic device and a second electronic device.

For example, the first electronic device can support a first telephone call mode for outputting a call voice received from the counterpart through its speaker and provide a call voice input through its microphone to the counterpart.

For example, the first electronic device can support a second telephone call mode for outputting a call voice received from the counterpart through a speaker of the second electronic device and provide a call voice of the user received from the second electronic device to the counterpart.

In FIGS. 7A and 7B, a device 703 (such as a smart device) worn on the left wrist of the user can be the second electronic device. A device 705 (such as a smart phone) held by the right band of the user can be the first electronic device.

In addition, the first electronic device 705 and the second electronic device 703 can change a telephone call mode automatically based on conditions information.

For example, the first electronic device 705 and the second electronic device 705 can change a telephone call mode based on position information.

FIGS. 7A and 7B illustrate conditions in which the user gets out of a predetermined position 701 (such as home) while establishing a call connection with a counterpart “jeremy” in the predetermined position using the second electronic device 601, he or she change a telephone call mode (such as reference number 707) and maintains the call connection using the first electronic device 705.

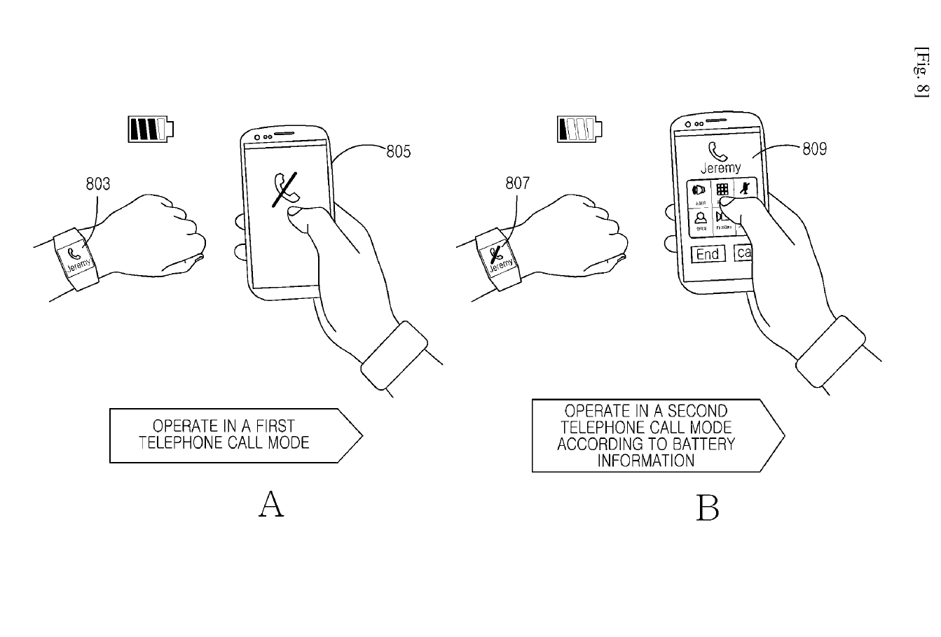

FIGS. 8A and 8B illustrate an example process of changing a telephone call module according to this disclosure.

Referring to FIGS. 8A and 8B, a user can establish a call connection with a counterpart using a first electronic device and a second electronic device.

For example, the first electronic device can support a first telephone call mode for outputting a call voice received from the counterpart through its speaker and provide a call voice input through its microphone to the counterpart.

For example, the first electronic device can support a second telephone call mode for outputting a call voice received from the counterpart through a speaker of the second electronic device and provide a call voice of the user received from the second electronic device to the counterpart.

In FIGS. 7A and 7B, a device 803 (such as a smart device) worn on the left wrist of the user can be the second electronic device. A device 805 (such as a smart phone) held by the right band of the user can be the first electronic device.

In addition, the first electronic device 705 and the second electronic device 705 can change a telephone call mode automatically based on conditions information.

For example, the first electronic device 805 and the second electronic device 803 can change a telephone call mode based on the remaining capacity of a battery of the second electronic device 803.

FIGS. 8A and 8B illustrate conditions in which the remaining capacity of the battery of the second electronic device 803 is insufficient while establishing a call connection with a counterpart “jeremy” using the second electronic device 803, he or she change a telephone call mode (such as reference number 807) and maintains the call connection using the first electronic device 805 (such as reference number 809).

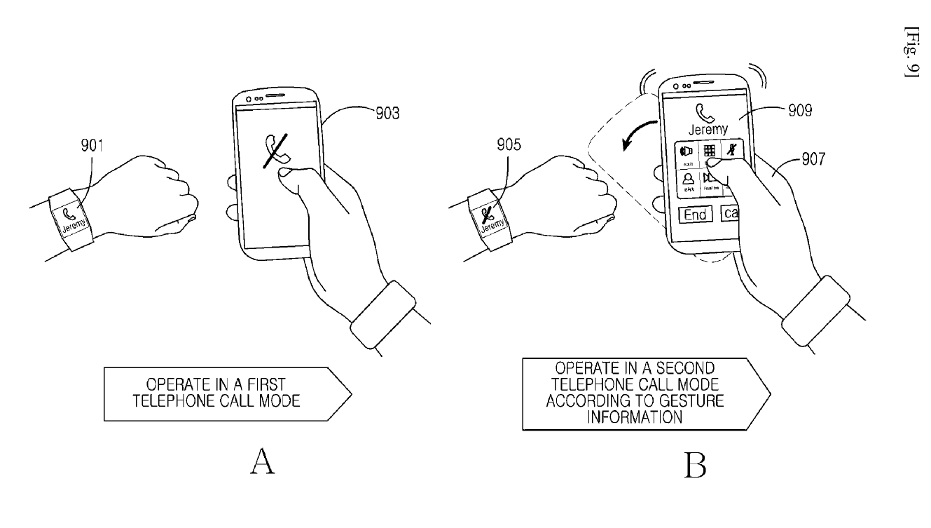

FIGS. 9A and 9B illustrate an example process of changing a telephone call module according to this disclosure.

Referring to FIGS. 9A and 9B, a user can establish a call connection with a counterpart using a first electronic device and a second electronic device.

For example, the first electronic device can support a first telephone call mode for outputting a call voice received from the counterpart through its speaker and provide a call voice input through its microphone to the counterpart.

For example, the first electronic device can support a second telephone call mode for outputting a call voice received from the counterpart through a speaker of the second electronic device and provide a call voice of the user received from the second electronic device to the counterpart.

In FIGS. 9A and 9B, a device 901 (such as a smart device) worn on the left wrist of the user can be the second electronic device. A device 903 (such as a smart phone) held by the right band of the user can be the first electronic device.

In addition, the first electronic device 903 and the second electronic device 901 can change a telephone call mode automatically based on conditions information.

For example, the first electronic device 903 and the second electronic device 901 can change a telephone call mode based on a change (907) in motion (such as reference number 905) and maintain a call connection using the first electronic device 903 (such as reference 909).

In addition, the electronic device can sense peripheral noises and change a telephone call mode. For example, determining that it is impossible to establish a call connection using a speaker of the second electronic device by peripheral noise, the first electronic device can perform a processing operation to maintain the call connection.

In various embodiments, the description was given for the contents for changing the telephone call mode. However, in addition, in various embodiments, the first electronic device can change an operation mode while the second electronic device corresponding to an extendable speaker reproduces audio media and video media. For example, when the video media are reproduced, the first electronic device can perform a control operation to recognize approach of the second electronic device or conditions information of the second electronic device and output audio data through itself or the second electronic device.

In an embodiment, an operation method of a first electronic device can include verifying an operation mode of the first electronic device when it is verified that a second electronic device is approached within a predetermined range while transmitting and receiving data with a third electronic device. The operation method of the first electronic device can also include changing a first operation mode to a second operation mode when the first electronic device operates in the first operation mode.

In an embodiment, verifying can include using any one of local-area communication and non-contact communication.

In an embodiment, the first operation mode can be a mode for establishing a call connection with the third electronic device using a speaker and microphone of the first electronic device. The second operation mode can be a mode for establishing a call connection with the third electronic device using a speaker and microphone of the second electronic device.

In an embodiment, the verification of the operation mode of the first electronic device can include verifying the approach of the second electronic device which is wearable on a body of a user of the second electronic device.

In an embodiment, the transmission and reception of the data with third electronic device can include transmitting and receiving at least any one of call data, and video and audio data of data reproduced by the third electronic device.

Each of the above-described elements of the electronic device according to various embodiments can be configured as one or more components. Names of the corresponding elements can differ according to kinds of the electronic devices. The electronic device according to various embodiments can be configured to include at least one of the above-described elements. Some elements can be omitted from the electronic device or the electronic device can further include additional elements. Also, some of the elements of the electronic device according to various embodiments can be combined to be configured as one entity. Therefore, functions of the corresponding elements before being combined can be equally performed.

The terms used in various embodiments, for example, the “module” can means, for example, a unit including one or combination of two or more of hardware, software, or firmware. The “module” can be interchangeably used with terms such as the unit, the logic, the logical block, the component, or the circuit. The “module” can be the minimum unit of a component which is integrally configured or some of the minimum unit. The “module” can be the minimum unit for performing one or more functions or some of the minimum unit. The “module” can be implemented mechanically or electronically. For example, the “module” according to various embodiments can include at least one of an Application-Specific Integrated Circuit (ASIC) chip, Field-Programmable Gate Arrays (FPGAs), or a programmable-logic device, each of them for performing certain operations, which will be developed in the future.

In accordance with various embodiments, at least a part of the device (such as modules or functions) or the method (such as operations) can be implemented, for example, as an instruction which is stored as a type of a programming module in computer-readable storage media. When the instruction is executed by one or more processors, the one or more processors can perform a function corresponding to the instruction. The computer-readable storage media can be, for example, a memory. At least a part of the programming module can be implemented (such as executed) by, for example, the processor. At least a part of the programming module can include, for example, a module, a program, a routine, sets of instructions, or a process, and the like, each of them for performing one or more functions.

The computer-readable storage media can include hardware devices which are particularly configured to store and perform program instructions (such as program modules), such as magnetic media such as a hard disc, a floppy disc, and a magnetic tape, optical media such as a Compact Disc Read Only Memory (CD-ROM) and a Digital Versatile Disc (DVD), magneto-optical media such as a floptical disk, a ROM, a Random Access Memory (RAM), a flash memory, and a memory. The program instruction can include not only a machine language code made by a compiler but also a high-level language code which can be executed by a computer using an interpreter, etc. The hardware device can be configured to operate as one or more software modules to perform operations according to various embodiments of the present invention. The opposite can also be configured as the same as being described above.

The module or the programming module according to various embodiments of the present disclosure can include at least one or more of the above-described elements. Some of the elements can be omitted from the module or the programming module or the module or the programming module can further include additional other elements. The module, the programming module, or operations performed by other elements can be executed by a sequential, parallel, repeated, or heuristic method. Also, some operations can be executed in the different order or be omitted. Other operations can be added to the some operations.

In accordance with various embodiments, in storage media which store instructions, the instructions are set to allow at least one processor to perform at least one operation when being executed by at least the one processor. At least the one operation can include an operation for verifying an operation mode of the first electronic device when the second electronic device is approached within a predetermined range while transmitting and receiving data with the third electronic device and an operation for changing the first mode to the second module when the first electronic device operates in the first mode.

In accordance with various embodiments vention, the electronic device can verify the approach of the second electronic device or recognize conditions information of the second electronic device and simplify a change operation of a telephone call mode.

While the present disclosure has been particularly shown and described with reference to exemplary embodiments thereof, it will be understood by those skilled in the art that various changes in form and details can be made therein without departing from the spirit and scope of the present disclosure as defined by the appended claims.

1. A method for use with a first electronic device, the method comprising:
verifying an operation mode of the first electronic device when it is verified that a second electronic device is approached within a predetermined range while transmitting and receiving data with a third electronic device; and
changing a first operation mode to a second operation mode when the first electronic device operates in the first operation mode.

2. The method of claim 1, wherein the approach of the second electronic device is verified using any one of local-area communication and non-contact communication.

3. The method of claim 1, wherein the first operation mode is a mode for establishing a call connection with the third electronic device using a speaker and microphone of the first electronic device and wherein the second operation mode is a mode for establishing a call connection with the third electronic device using a speaker and microphone of the second electronic device.

4. The method of claim 1, wherein the verification of the operation mode of the first electronic device comprises verifying the approach of the second electronic device which is wearable on a body of a user of the second electronic device.

5. The method of claim 1, wherein the transmission and reception of the data with third electronic device comprises transmitting and receiving at least any one of call data, video data, and audio data of data reproduced by the third electronic device.

6. A first electronic device comprising:
at least one processor; and
a memory,
wherein at least the one processor is configured to output call data received from a third electronic device through a second electronic device, transmit call data provided from the second electronic device to the third electronic device, and change a telephone call mode based on approach of the second electronic device or conditions information of the second electronic device.

7. The first electronic device of claim 6, wherein at least the one processor is configured to change a telephone call mode to output call data received from the third electronic device through a speaker of the first electronic device and transmit call data input from a microphone of the first electronic device to the third electronic device.

8. The first electronic device of claim 6, wherein at least the one processor is configured to verify approach of the second electronic device through non-contact communication.

9. The first electronic device of claim 6, wherein at least the one processor is configured to recognize conditions information based on any one of motion information, position information, remaining capacity information of a battery, time information, and peripheral noise information.

10. The first electronic device of claim 6, wherein at least the one processor is configured to verify approach of the second electronic device in a state where the first electronic device connects with the second electronic device using local-area communication.

11. The first electronic device of claim 6, wherein at least the one processor is configured to sense a tagging operation with the second electronic device and verify approach of the second electronic device.

12. The first electronic device of claim 11, wherein at least the one processor is configured to determine that the first electronic device is tagged with the second electronic device when the first electronic device comes in contact with the second electronic device physically or is adjacent to the second electronic device.

13. The first electronic device of claim 6, wherein the second electronic device is configured to include at least any one of an extendable speaker and an electronic watch.

14. The first electronic device of claim 6, wherein at least the one processor is configured to output call data received from the third electronic device through the second electronic device through at least any one of a CDMA network, a W-CDMA network, a GSM network, and a VoIP network.

15. An electronic device comprising:
a first communication unit configured to establish a connection with a second electronic device;
a second communication unit configured to establish a connection with a third electronic device; and
a processor configured to:
if the second electronic device is approached within a predetermined range while connection with the third electronic device, verify an operation mode of the electronic device,
if the electronic device operates in the first operation mode, change the first operation mode to a second operation mode, and
if the electronic device operates in the second operation mode, change the second operation mode to the first operation mode.
